(19) United States
(12) Patent Application Publication
(10) Pub. No.: US 2005/0202296 A1
(43) Pub. Date: Sep. 15, 2005

(54) Low cost fuel cell bipolar plates manufactured from conductive loaded resin-based materials

(75) Inventor: Thomas Aisenbrey, Littleton, CO (US)

Correspondence Address: STEPHEN B. ACKERMAN, 28 DAVIS AVENUE, POUGHKEEPSIE, NY, 12603, US

(73) Assignee: Integral Technologies, Inc.

(21) Appl. No.: 11/096,608

(22) Filed: Apr. 1, 2005

Related U.S. Application Data
(63) Continuation-in-part of application No. 10/877,092, filed on Jun. 25, 2004.
Application No. 10/877,092 is a continuation of application No. 10/309,429, filed on Dec. 4, 2002, now Pat. No. 6,870,516.
Application No. 10/309,429 is a continuation-in-part of application No. 10/075,778, filed on Feb. 14, 2002, now Pat. No. 6,741,221.
(60) Provisional application No. 60/561,757, filed on Apr. 13, 2004.
(60) Provisional application No. 60/317,808, filed on Sep. 7, 2001.
(60) Provisional application No. 60/269,414, filed on Feb. 16, 2001.
(60) Provisional application No. 60/268,822, filed on Feb. 15, 2001.

(51) Int. Cl. H01M 4/00

(52) U.S. Cl. 429/27

(57) ABSTRACT

Mono-polar and bipolar fuel cell plates are formed of a conductive loaded resin-based material. The conductive loaded resin-based material comprises micron conductive powder(s), conductive fiber(s), or a combination of conductive powder and conductive fibers in a base resin host. The percentage by weight of the conductive powder(s), conductive fiber(s), or a combination thereof is between about 20% and 50% of the weight of the conductive loaded resin-based material. The micron conductive powders are formed from non-metals, such as carbon, graphite, that may also be metallic plated, or the like, or from metals such as stainless steel, nickel, copper, silver, that may also be metallic plated, or the like, or from a combination of non-metal, plated, or in combination with, metal powders. The micron conductor fibers preferably are of nickel plated carbon fiber, stainless steel fiber, copper fiber, silver fiber, aluminum fiber, or the like.

This patent application claims priority to the U.S. Provisional Patent Application 60/561,757 filed on Apr. 13, 2004 which is herein incorporated by reference in its entirety.

This patent application is a Continuation-in-Part of INT01-002CIPC, filed as U.S. patent application Ser. No. 10/877,092, filed on Jun. 25, 2004, which is a Continuation of INT01-002CIP, filed as U.S. patent application Ser. No. 10/309,429, filed on Dec. 4, 2002, also incorporated by reference in its entirety, which is a Continuation-in-Part application of docket number INT01-002, filed as U.S. patent application Ser. No. 10/075,778, filed on Feb. 14, 2002, now issued as U.S. Pat. No. 6,741,221, which claimed priority to U.S. Provisional Patent Applications Ser. No. 60/317,808, filed on Sep. 7, 2001, Ser. No. 60/269,414, filed on Feb. 16, 2001, and Ser. No. 60/268,822, filed on Feb. 15, 2001.

### BACKGROUND OF THE INVENTION

(1) Field of the Invention

This invention relates to fuel cells and, more particularly, to bipolar fuel cells molded of conductive loaded resin-based materials comprising micron conductive powders, micron conductive fibers, or a combination thereof, substantially homogenized within a base resin when molded. This manufacturing process yields a conductive part or material usable within the EMF or electronic spectrum(s).

(2) Description of the Prior Art

Fuel cells are electrochemical devices that convert fuel directly into electricity. Fuel cells are essentially a form of a battery wherein electrical energy is generated by a chemical reaction. However, unlike batteries, fuel cells require a constant flow of fuel to continue to work. The best known fuel cell technology is that of the hydrogen fuel cell. In a hydrogen fuel cell, a pure hydrogen source, such as gaseous H₂, liquid H₂, or a hydrogen-containing source, such as methanol or metal hydride, is directed to one side of a proton exchange membrane. The proton exchange membrane has several unique properties. First, the membrane catalyses the removal of an electron (e⁻) from the hydrogen atom to thereby generate a proton (H⁺). Second, the membrane allows passage of the proton through the membrane. Third, the membrane is not conductive and, therefore, the free electron does not pass through the membrane. As a result of these features, a free electron and a free proton are generated each time the reaction occurs according to:
2H₂→4H⁺+4e⁻
At the same time, an oxygen source, such as gaseous O₂ is provided to the other side of the membrane. When the free protons pass from the hydrogen side to the oxygen side, these positive charged protons react with the available oxygen to form water according to the reaction:
O₂+4H⁺+4e⁻→2H₂O
Note, however, that the electrons (4e⁻) generated in the hydrogen side reaction are not available for the oxygen side reaction because the membrane does not allow electron flow. Therefore, the electrons 4e⁻ of the oxygen side reaction must be supplied. If an additional conductive path is established between the hydrogen side and the oxygen side, the above reaction will generate a net current flow of electrons out from the hydrogen side and into the oxygen side. To this effect, the oxygen side forms a cathode (+) of the fuel cell and the hydrogen side forms an anode (−) of the fuel cell. When a current conducting load is connected between the anode and the cathode, then the additional conductive path is established. As long as fuel is continuously provided to the fuel cell to replace lost reactants, then the cell will continue to provide electrical power.

The standard electrochemical reaction described above only generates about 1 Volt. Therefore, to create a multiple volt cell, a group of sub-cells must be strung together in series to form a stack. To accomplish this task each sub-cell is designed with a stand-alone cathode, anode, and membrane. Further, sub-cells typically also contain diffusion layers to diffuse the reacting fuel over the membrane surface and/or catalyst layers to thereby catalyze the reaction. On each side of the membrane several additional mechanisms must be provided. First, a means to flow fuel (hydrogen and oxygen) to the membrane must be provided. Second, a means of flowing reactant product (water) away from the membrane must be provided. Third, a means of transferring heat away from, or in some cases into, the membrane area may have to be provided. Fourth, a means of flowing electrical current must be provided. All of these requirements are typically met using mono-polar or bipolar plates.

Each sub-cell has a cathode plate and an anode plate. These plates meet the above requirements by providing mechanical and electrical channels for flowing both reacting fuels and reactant products. If two sub-cells in the overall fuel cell design are adjacent, then the anode of a first cell will be electrically shorted to the cathode of a second cell. Therefore, it is typical in fuel cell designs for a single structure to be used that functions as a cathode-anode, or bipolar, plate. On one side of the bipolar plate, hydrogen fuel is routed through channels to a membrane. On the other side of the bipolar plate, oxygen is routed to the membrane while water is routed away from the membrane. The flow channels of the bipolar plate normally comprise small slots or labyrinth-styled passageways to “guide” the gas to the membrane of the fuel cell and to maximize gas diffusion to the electrode for reaction to take place. If a sub-cell is the last sub-cell in a chain, then it will have a plate that ends the chain. This plate is called an end plate or a mono-polar plate. It can be seen that, in addition to handling fuel flow, water flow, current flow, and heat flow, the bipolar plates also must be constructed such that the fuel fluids will not penetrate through the plate. Additional and important considerations in mono-polar and bipolar plate design are resistance to corrosion and non-reaction with fuels and reaction products. In mobile applications, a further consideration is weight.

Presently, bipolar fuel cell plates are made of metallic or graphite materials. Metals can be excellent for thermal and electrical characteristics but are often heavy, expensive, and easy to corrode. Graphite-based materials are excellent for non-corrosion but limited in thermal and electrical characteristics and in ease of manufacture. A principle object of the present invention is to provide a mono-polar and bipolar fuel cell plates having improved performance characteristics and excellent cost-to-benefit advantages.

Several prior art inventions relate to bipolar fuel cells and related technologies. U.S. Patent Publication U.S. 2004/0197638 A1 to McElrath et al teaches a fuel cell electrode comprising carbon nanotubes with enough conductivity and porosity that the gas diffusion layers and bipolar plates can be eliminated from the fuel cell. U.S. Pat. No. 6,828,055 B2 to Kearl teaches bipolar plates and end plates for fuel cells and their method of manufacture. This patent teaches the use of a doped semi-conductive material or a conductive metal with etched flow channels on both sides for making the bipolar plates. U.S. Patent Publication U.S. 2004/0157108 A1 to Blunk et al teaches a low contact resistance PEM fuel cell that utilizes bipolar plates formed of a polymer composite. The polymer composite comprises a thermoplastic or thermoset material with a conductive filler selected from the group consisting of gold, platinum, graphite, conductive carbon, palladium, rhodium, ruthenium, and rare earth metals. This invention also teaches that the bipolar plates are then covered with a smearing of a hyper conductive graphite material. U.S. Patent Publication U.S. 2004/0028984 A1 to DeFilippis teaches a bipolar plate that has an integrated gas-permeable membrane. The patent teaches the gas-permeable membrane to be a hydrophobic polymer with a high capacity to remove carbon dioxide from the anode chamber of each fuel cell. U.S. Patent Publication U.S. 2004/0023095 A1 to Middelman et al teaches the production of a PEM fuel cell plate, half-cell or bipolar plate comprising a good conducting area, a poor conducting area or a non conducting area. This patent utilizes graphite powder as filler in order to render the resin conductive. U.S. Patent Publication U.S. 2003/0219646 A1 to LeCostaouec teaches a carbon fiber reinforced plastic bipolar plate with continuous electrical pathways. This invention utilizes pre-oxidized PAN fibers, thermoset pitch fibers, graphitized PAN fibers, or carbonized pitch fibers as the conductive filler. U.S. Patent Publication U.S. 2003/0160352 A1 to Middelman teaches a method for the production of a conductive composite material for use in forming electrodes in a PEM fuel cell. This invention utilizes a mixture of a conductive powder with particle size of between 10-300 micron, a second conductive powder with a particle size of less than 1 micron, and a non-conductive polymer powder to form the conductive sheet material. U.S. Patent Publication U.S. 2003/0124414 A1 to Hertel et al teaches a porous carbon body for a fuel cell having an electronically conductive hydrophilic agent. The invention utilizes an electronically conductive graphite powder, a carbon fiber, a thermoset binder, and a modified carbon black electronically conductive hydrophilic agent for forming the porous carbon body. U.S. Patent Publication U.S. 2003/0041444 A1 to Debe et al teaches membrane electrode assemblies for use in fuel cells, electrolyzers and electrochemical reactors. The invention utilizes carbon as a filler to create the porous electrically conductive polymer film. U.S. Pat. No. 4,124,747 to Murer et al teaches a conductive polyolefin sheet element that utilizes carbon black as filler for forming bipolar plates.

### SUMMARY OF THE INVENTION

A principal object of the present invention is to provide an effective mono-polar or bipolar fuel cell plate.

A further object of the present invention is to provide a method to form a mono-polar or bipolar fuel cell plate.

A further object of the present invention is to provide a mono-polar or bipolar fuel cell plate molded of conductive loaded resin-based materials.

A further object of the present invention is to provide a fuel cell plate having excellent resistance to corrosion.

A further object of the present invention is to provide a fuel cell plate having excellent electrical conductivity.

A further object of the present invention is to provide a fuel cell plate having excellent thermal conductivity.

A further object of the present invention is to provide a fuel cell plate that is not permeable to fluid fuels.

A further object of the present invention is to provide a fuel cell plate having low weight.

A further object of the present invention is to provide a fuel cell plate having excellent manufacturability.

A yet further object of the present invention is to provide a mono-polar or bipolar plate for a fuel cell molded of conductive loaded resin-based material where the performance characteristics can be altered by forming a metal layer over the conductive loaded resin-based material.

A yet further object of the present invention is to provide methods to fabricate mono-polar or bipolar plate for a fuel cell from a conductive loaded resin-based material incorporating various forms of the material.

In accordance with the objects of this invention, a conductive fuel cell plate device is achieved. The device comprises a substrate comprising a conductive loaded, resin-based material comprising conductive materials in a base resin host. A first channel is formed on a side of the substrate.

Also in accordance with the objects of this invention, a fuel cell device is achieved. The device comprises a cathode end plate comprising a conductive loaded, resin-based material comprising conductive materials in a base resin host. A channel is formed on a side of the cathode end plate. A proton conducting membrane is placed between the cathode end plate and an anode end plate. The anode end plate comprises the conductive loaded, resin-based material. A channel is formed on a side of the cathode end plate.

Also in accordance with the objects of this invention, a fuel cell device is achieved. The device comprises a cathode end plate comprising a conductive loaded, resin-based material comprising conductive materials in a base resin host. A channel is formed on a side of the cathode end plate. A proton conducting membrane is placed between the cathode end plate and an anode end plate. The anode end plate comprises the conductive loaded, resin-based material. A channel is formed on a side of the cathode end plate. The percent by weight of said conductive materials is between 20% and 40% of the total weight of said conductive loaded resin-based material.

Also in accordance with the objects of this invention, a method to form a conductive fuel cell plate device is achieved. The method comprises providing a conductive loaded, resin-based material comprising conductive materials in a resin-based host. The conductive loaded, resin-based material is molded into a conductive fuel cell plate. A first channel is formed on a side of said plate.

Also in accordance with the objects of this invention, a method to form a conductive fuel cell plate device is achieved. The method comprises providing a conductive loaded, resin-based material comprising conductive materials in a resin-based host. The conductive loaded, resin-based material is molded into a conductive fuel cell plate. A first channel is formed on a side of said plate. The percent by weight of the conductive materials is between 20% and 40% of the total weight of the conductive loaded resin-based material.

Also in accordance with the objects of this invention, a method to form a conductive fuel cell plate device is achieved. The method comprises providing a conductive loaded, resin-based material comprising conductive materials in a resin-based host. The conductive loaded, resin-based material is molded into a conductive fuel cell plate. A first channel is formed on a side of said plate. The conductive loaded resin-based material comprises micron conductive fiber in a resin-based host. The percent by weight of the micron conductive fiber is between 25% and 35% of the total weight of the conductive loaded resin-based material.

### BRIEF DESCRIPTION OF THE DRAWINGS

In the accompanying drawings forming a material part of this description, there is shown:

FIG. 1 illustrates a first preferred embodiment of the present invention showing a fuel cell device comprising a conductive loaded resin-based material.

FIG. 2 illustrates a first preferred embodiment of a conductive loaded resin-based material wherein the conductive materials comprise a powder.

FIG. 3 illustrates a second preferred embodiment of a conductive loaded resin-based material wherein the conductive materials comprise micron conductive fibers.

FIG. 4 illustrates a third preferred embodiment of a conductive loaded resin-based material wherein the conductive materials comprise both conductive powder and micron conductive fibers.

FIGS. 5a and 5b illustrate a fourth preferred embodiment wherein conductive fabric-like materials are formed from the conductive loaded resin-based material.

FIGS. 6a and 6b illustrate, in simplified schematic form, an injection molding apparatus and an extrusion molding apparatus that may be used to mold mono-polar or bipolar plates for a fuel cell of a conductive loaded resin-based material.

FIG. 7 illustrates a second preferred embodiment of the present invention showing a cross section of a fuel cell device having mono-polar and bipolar plates comprising conductive loaded resin-based material.

FIG. 8 illustrates a third preferred embodiment of the present invention showing a side view of a single mono-polar or bipolar plate comprising conductive loaded resin-based material.

FIG. 9 illustrates a fourth preferred embodiment of the present invention showing a cross section of a conductive plate comprising the conductive loaded resin-based material and having thermal control channels formed therein.

### DESCRIPTION OF THE PREFERRED EMBODIMENTS

This invention relates to mono-polar or bipolar fuel cell plates molded of conductive loaded resin-based materials comprising micron conductive powders, micron conductive fibers, or a combination thereof, substantially homogenized within a base resin when molded.

The conductive loaded resin-based materials of the invention are base resins loaded with conductive materials, which then makes any base resin a conductor rather than an insulator. The resins provide the structural integrity to the molded part. The micron conductive fibers, micron conductive powders, or a combination thereof, are substantially homogenized within the resin during the molding process, providing the electrical continuity.

The conductive loaded resin-based materials can be molded, extruded or the like to provide almost any desired shape or size. The molded conductive loaded resin-based materials can also be cut, stamped, or vacuumed formed from an injection molded or extruded sheet or bar stock, over-molded, laminated, milled or the like to provide the desired shape and size. The thermal or electrical conductivity characteristics of mono-polar or bipolar fuel cell plates fabricated using conductive loaded resin-based materials depend on the composition of the conductive loaded resin-based materials, of which the loading or doping parameters can be adjusted, to aid in achieving the desired structural, electrical or other physical characteristics of the material. The selected materials used to fabricate the mono-polar or bipolar fuel cell plates are substantially homogenized together using molding techniques and or methods such as injection molding, over-molding, insert molding, thermo-set, protrusion, extrusion or the like. Characteristics related to 2D, 3D, 4D, and 5D designs, molding and electrical characteristics, include the physical and electrical advantages that can be achieved during the molding process of the actual parts and the polymer physics associated within the conductive networks within the molded part(s) or formed material(s).

In the conductive loaded resin-based material, electrons travel from point to point when under stress, following the path of least resistance. Most resin-based materials are insulators and represent a high resistance to electron passage. The doping of the conductive loading into the resin-based material alters the inherent resistance of the polymers. At a threshold concentration of conductive loading, the resistance through the combined mass is lowered enough to allow electron movement. Speed of electron movement depends on conductive loading concentration, that is, the separation between the conductive loading particles. Increasing conductive loading content reduces interparticle separation distance, and, at a critical distance known as the percolation point, resistance decreases dramatically and electrons move rapidly.

Resistivity is a material property that depends on the atomic bonding and on the microstructure of the material. The atomic microstructure material properties within the conductive loaded resin-based material are altered when molded into a structure. A substantially homogenized conductive microstructure of delocalized valance electrons is created. This microstructure provides sufficient charge carriers within the molded matrix structure. As a result, a low density, low resistivity, lightweight, durable, resin based polymer microstructure material is achieved. This material exhibits conductivity comparable to that of highly conductive metals such as silver, copper or aluminum, while maintaining the superior structural characteristics found in many plastics and rubbers or other structural resin based materials.

The use of conductive loaded resin-based materials in the fabrication of mono-polar or bipolar fuel cell plates significantly lowers the cost of materials and the design and manufacturing processes used to hold ease of close tolerances, by forming these materials into desired shapes and sizes. The mono-polar or bipolar fuel cell plates can be manufactured into infinite shapes and sizes using conventional forming methods such as injection molding, over-molding, or extrusion or the like. The conductive loaded resin-based materials, when molded, typically but not exclusively produce a desirable usable range of resistivity from between about 5 and 25 ohms per square, but other resistivities can be achieved by varying the doping parameters and/or resin selection(s).

The conductive loaded resin-based materials comprise micron conductive powders, micron conductive fibers, or any combination thereof, which are substantially homogenized together within the base resin, during the molding process, yielding an easy to produce low cost, electrically conductive, close tolerance manufactured part or circuit. The resulting molded article comprises a three dimensional, continuous network of conductive loading and polymer matrix. The micron conductive powders can be of carbons, graphites, amines or the like, and/or of metal powders such as nickel, copper, silver, aluminum, or plated or the like. The use of carbons or other forms of powders such as graphite(s) etc. can create additional low level electron exchange and, when used in combination with micron conductive fibers, creates a micron filler element within the micron conductive network of fiber(s) producing further electrical conductivity as well as acting as a lubricant for the molding equipment. The micron conductive fibers can be nickel plated carbon fiber, stainless steel fiber, copper fiber, silver fiber, aluminum fiber, or the like, or combinations thereof. Superconductor metals, such as titanium, nickel, niobium, and zirconium, and alloys of titanium, nickel, niobium, and zirconium may also be used as micron conductive fibers in the present invention. The structural material is a material such as any polymer resin. Structural material can be, here given as examples and not as an exhaustive list, polymer resins produced by GE PLASTICS, Pittsfield, Mass., a range of other plastics produced by GE PLASTICS, Pittsfield, Mass., a range of other plastics produced by other manufacturers, silicones produced by GE SILICONES, Waterford, N.Y., or other flexible resin-based rubber compounds produced by other manufacturers.

The resin-based structural material loaded with micron conductive powders, micron conductive fibers, or in combination thereof can be molded, using conventional molding methods such as injection molding or over-molding, or extrusion to create desired shapes and sizes. The molded conductive loaded resin-based materials can also be stamped, cut or milled as desired to form create the desired shape form factor(s) of the mono-polar or bipolar fuel cell plates. The doping composition and directionality associated with the micron conductors within the loaded base resins can affect the electrical and structural characteristics of the mono-polar or bipolar fuel cell plates and can be precisely controlled by mold designs, gating and or protrusion design(s) and or during the molding process itself. In addition, the resin base can be selected to obtain the desired thermal characteristics such as very high melting point or specific thermal conductivity.

A resin-based sandwich laminate could also be fabricated with random or continuous webbed micron stainless steel fibers or other conductive fibers, forming a cloth like material. The webbed conductive fiber can be laminated or the like to materials such as Teflon, Polyesters, or any resin-based flexible or solid material(s), which when discretely designed in fiber content(s), orientation(s) and shape(s), will produce a very highly conductive flexible cloth-like material. Such a cloth-like material could also be used in forming devices that could be embedded in a person's clothing as well as other resin materials such as rubber(s) or plastic(s). When using conductive fibers as a webbed conductor as part of a laminate or cloth-like material, the fibers may have diameters of between about 3 and 12 microns, typically between about 8 and 12 microns or in the range of about 10 microns, with length(s) that can be seamless or overlapping.

The conductive loaded resin-based material of the present invention can be made resistant to corrosion and/or metal electrolysis by selecting micron conductive fiber and/or micron conductive powder and base resin that are resistant to corrosion and/or metal electrolysis. For example, if a corrosion/electrolysis resistant base resin is combined with stainless steel fiber and carbon fiber/powder, then a corrosion and/or metal electrolysis resistant conductive loaded resin-based material is achieved. Another additional and important feature of the present invention is that the conductive loaded resin-based material of the present invention may be made flame retardant. Selection of a flame-retardant (FR) base resin material allows the resulting product to exhibit flame retardant capability. This is especially important in mono-polar or bipolar fuel cell plates as described herein.

The substantially homogeneous mixing of micron conductive fiber and/or micron conductive powder and base resin described in the present invention may also be described as doping. That is, the substantially homogeneous mixing converts the typically non-conductive base resin material into a conductive material. This process is analogous to the doping process whereby a semiconductor material, such as silicon, can be converted into a conductive material through the introduction of donor/acceptor ions as is well known in the art of semiconductor devices. Therefore, the present invention uses the term doping to mean converting a typically non-conductive base resin material into a conductive material through the substantially homogeneous mixing of micron conductive fiber and/or micron conductive powder into a base resin.

As an additional and important feature of the present invention, the molded conductor loaded resin-based material exhibits excellent thermal dissipation characteristics. Therefore, mono-polar or bipolar fuel cell plates manufactured from the molded conductor loaded resin-based material can provide added thermal dissipation capabilities to the application. For example, heat can be dissipated from electrical devices physically and/or electrically connected to a device of the present invention.

As a significant advantage of the present invention, mono-polar or bipolar fuel cell plates constructed of the conductive loaded resin-based material can be easily interfaced to an electrical circuit or grounded. In one embodiment, a wire can be attached to a conductive loaded resin-based device via a screw that is fastened to the device. For example, a simple sheet-metal type, self tapping screw, when fastened to the material, can achieve excellent electrical connectivity via the conductive matrix of the conductive loaded resin-based material. To facilitate this approach a boss may be molded into the conductive loaded resin-based material to accommodate such a screw. Alternatively, if a solderable screw material, such as copper, is used, then a wire can be soldered to the screw that is embedded into the conductive loaded resin-based material. In another embodiment, the conductive loaded resin-based material is partly or completely plated with a metal layer. The metal layer forms excellent electrical conductivity with the conductive matrix. A connection of this metal layer to another circuit or to ground is then made. For example, if the metal layer is solderable, then a soldered connection may be made between the device and a grounding wire.

A typical metal deposition process for forming a metal layer onto the conductive loaded resin-based material is vacuum metallization. Vacuum metallization is the process where a metal layer, such as aluminum, is deposited on the conductive loaded resin-based material inside a vacuum chamber. In a metallic painting process, metal particles, such as silver, copper, or nickel, or the like, are dispersed in an acrylic, vinyl, epoxy, or urethane binder. Most resin-based materials accept and hold paint well, and automatic spraying systems apply coating with consistency. In addition, the excellent conductivity of the conductive loaded resin-based material of the present invention facilitates the use of extremely efficient, electrostatic painting techniques.

The conductive loaded resin-based material can be contacted in any of several ways. In one embodiment, a pin is embedded into the conductive loaded resin-based material by insert molding, ultrasonic welding, pressing, or other means. A connection with a metal wire can easily be made to this pin and results in excellent contact to the conductive loaded resin-based material. In another embodiment, a hole is formed in to the conductive loaded resin-based material either during the molding process or by a subsequent process step such as drilling, punching, or the like. A pin is then placed into the hole and is then ultrasonically welded to form a permanent mechanical and electrical contact. In yet another embodiment, a pin or a wire is soldered to the conductive loaded resin-based material. In this case, a hole is formed in the conductive loaded resin-based material either during the molding operation or by drilling, stamping, punching, or the like. A solderable layer is then formed in the hole. The solderable layer is preferably formed by metal plating. A conductor is placed into the hole and then mechanically and electrically bonded by point, wave, or reflow soldering.

Another method to provide connectivity to the conductive loaded resin-based material is through the application of a solderable ink film to the surface. One exemplary solderable ink is a combination of copper and solder particles in an epoxy resin binder. The resulting mixture is an active, screen-printable and dispensable material. During curing, the solder reflows to coat and to connect the copper particles and to thereby form a cured surface that is directly solderable without the need for additional plating or other processing steps. Any solderable material may then be mechanically and/or electrically attached, via soldering, to the conductive loaded resin-based material at the location of the applied solderable ink. Many other types of solderable inks can be used to provide this solderable surface onto the conductive loaded resin-based material of the present invention. Another exemplary embodiment of a solderable ink is a mixture of one or more metal powder systems with a reactive organic medium. This type of ink material is converted to solderable pure metal during a low temperature cure without any organic binders or alloying elements.

A ferromagnetic conductive loaded resin-based material may be formed of the present invention to create a magnetic or magnetizable form of the material. Ferromagnetic micron conductive fibers and/or ferromagnetic conductive powders are mixed with the base resin. Ferrite materials and/or rare earth magnetic materials are added as a conductive loading to the base resin. With the substantially homogeneous mixing of the ferromagnetic micron conductive fibers and/or micron conductive powders, the ferromagnetic conductive loaded resin-based material is able to produce an excellent low cost, low weight magnetize-able item. The magnets and magnetic devices of the present invention can be magnetized during or after the molding process. The magnetic strength of the magnets and magnetic devices can be varied by adjusting the amount of ferromagnetic micron conductive fibers and/or ferromagnetic micron conductive powders that are incorporated with the base resin. By increasing the amount of the ferromagnetic doping, the strength of the magnet or magnetic devices is increased. The substantially homogenous mixing of the conductive fiber network allows for a substantial amount of fiber to be added to the base resin without causing the structural integrity of the item to decline. The ferromagnetic conductive loaded resin-based magnets display the excellent physical properties of the base resin, including flexibility, moldability, strength, and resistance to environmental corrosion, along with excellent magnetic ability. In addition, the unique ferromagnetic conductive loaded resin-based material facilitates formation of items that exhibit excellent thermal and electrical conductivity as well as magnetism.

A high aspect ratio magnet is easily achieved through the use of ferromagnetic conductive micron fiber or through the combination of ferromagnetic micron powder with conductive micron fiber. The use of micron conductive fiber allows for molding articles with a high aspect ratio of conductive fiber to cross sectional area. If a ferromagnetic micron fiber is used, then this high aspect ratio translates into a high quality magnetic article. Alternatively, if a ferromagnetic micron powder is combined with micron conductive fiber, then the magnetic effect of the powder is effectively spread throughout the molded article via the network of conductive fiber such that an effective high aspect ratio molded magnetic article is achieved. The ferromagnetic conductive loaded resin-based material may be magnetized, after molding, by exposing the molded article to a strong magnetic field. Alternatively, a strong magnetic field may be used to magnetize the ferromagnetic conductive loaded resin-based material during the molding process.

Exemplary ferromagnetic conductive fiber materials include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive fiber materials. Exemplary non-ferromagnetic conductor fibers include stainless steel, nickel, copper, silver, aluminum, or other suitable metals or conductive fibers, alloys, plated materials, or combinations thereof. Superconductor metals, such as titanium, nickel, niobium, and zirconium, and alloys of titanium, nickel, niobium, and zirconium may also be used as micron conductive fibers in the present invention. Exemplary ferromagnetic micron powder leached onto the conductive fibers include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive powder materials.

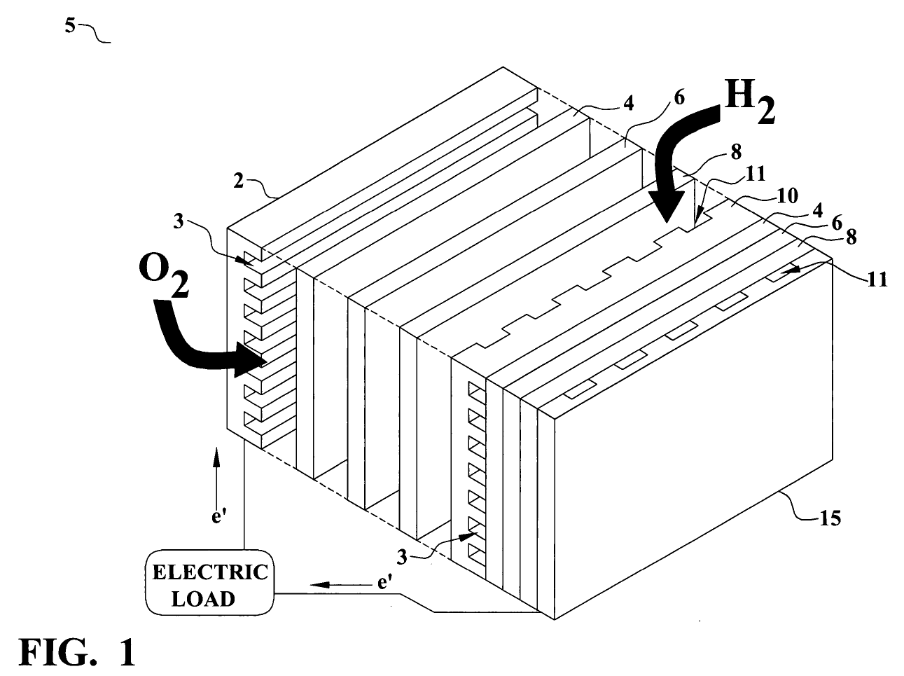

Referring now to FIG. 1, a first preferred embodiment of the present invention is illustrated. A fuel cell device 5 is shown in a partially exploded view. Several important features of the present invention are shown and discussed below. The fuel cell device 5 comprises mono-polar plates 2 and 15, a bipolar plate 10, and membrane electrode assemblies 4, 6, and 8. As an important feature of the present invention, any or all of the mono-polar and bipolar plates 2, 15, and 10 comprise the conductive loaded resin-based material of the present invention.

In the illustrated embodiment, a cathode end plate 2 is formed with horizontal channels 3 formed therein to direct the flow of oxygen (O₂) through the end cell of the fuel cell stack 5. The cathode end plate 2 additionally forms the conductive end connection of the fuel cell stack 5. Each membrane electrode assembly is formed of a cathode side diffusion layer 4, the proton-conducting membrane 6, and an anode side diffusion layer 8. The bipolar plate 10 has vertical channels 11 that direct the flow of the hydrogen source, such as H₂, through the sub-cell area. The bipolar plate 10 further has channels 3 for directing the flow of the oxygen source, such as O₂, through the sub-cell area. The bipolar plate 10 is placed between adjacent membrane electrode assemblies 4, 6, and 8. The anode end plate 15 is formed with vertical channels 11 that direct the flow of the hydrogen source through the anode end cell of the fuel cell stack 5.

Since each cell of a fuel cell stack 5 generates approximately 1.0V, a fuel cell stack will have a number of cells to develop the desired voltage. Once the desired number of cells is stacked together the fuel cell 5 is completed. To operate the cell, the cathode end plate 2 and the anode end plate 15 are connected the electrical load 20. The hydrogen source and the oxygen source are forced into the cell 5 to cause electrical current (e⁻) to flow from the anode end plate 15 through the electrical load and into the cathode end plate 2. The hydrogen (H₂) is oxidized and the oxygen (O₂) reduced to generated energy as described above. In one embodiment of the present invention, the cathode (mono-polar) end plate 2, the bipolar fuel cell plate 10, and the anode (mono-polar) end plate 15 each comprise conductive loaded resin-based materials as described in herein.

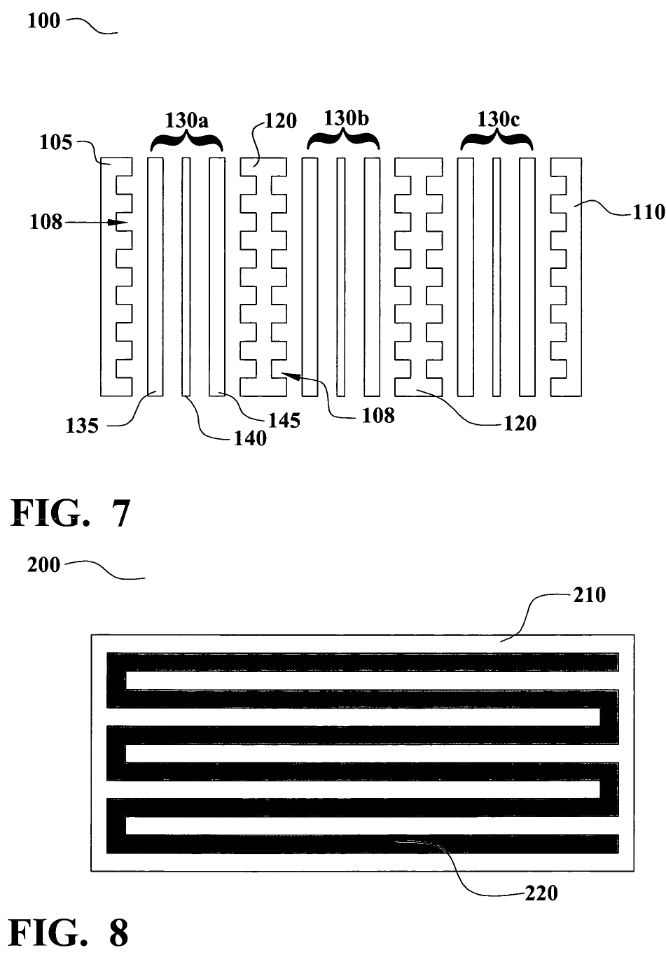

Referring now to FIG. 7, a second preferred embodiment of the present invention is illustrated. A cross sectional view of a fuel cell 100 is shown. Membrane electrode assemblies 130a, 130b, and 130 are sandwiched between end plates 105 and 110 and bipolar plates 120. Each membrane electrode assembly comprises a center membrane 140 sandwiched by diffusion layers 135 and 145. The cross sectional view more fully shows a plurality of channels 108 in the mono-polar and bipolar plates 105, 110, and 120. These channels are used to direct the flow of fuel into the cell 100 and to direct the flow of reaction product (water) out from the cell 100. In one preferred embodiment the end plates 105 and 110 and the bipolar plates 120 each comprise the conductive loaded resin-based material of the present invention.

Referring now to FIG. 8, a third preferred embodiment of the present invention is illustrated. A side view of a single bipolar or mono-polar plate 200 is shown. The plate 200 comprises the conductive loaded resin-based material of the present invention. Channels 220 are formed into the bulk conductive loaded resin-based material 210. In one embodiment, the plate 200 is formed by injection molding the conductive loaded resin-based material. In another embodiment, the conductive loaded resin-based material is extruded to form the plate 200. In another embodiment, a calendaring process is used to form a thin sheet of the conductive loaded resin-based material. This sheet is then heat pressed to cut the required shape and to form the channels 220. In yet another embodiment, blank plates are first formed by any method such as calendaring. These blank plates are then heat pressed to form the channels 200.

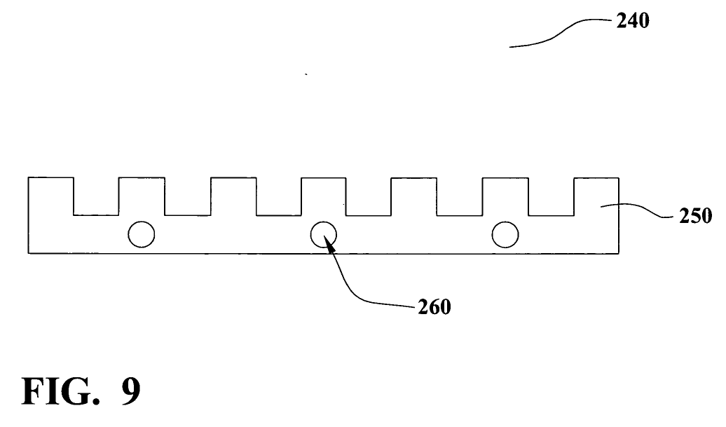

Referring now to FIG. 9, a fourth preferred embodiment 240 of the present invention is illustrated. A cross section of another mono-polar plate 240 is shown. In this case, thermal regulating, fluid carrying channels 260 are formed into the plate 250. These fluid carrying channels 260 are isolated from the fuel or reactant product channels molded into the surface topology or the plate 250. The fluid carrying channels 260 are useful for regulating the temperature of the plate 250. As described above, the fuel cell reaction generates energy both in the form of electrical energy and in the form of heat. To maintain proper operation, especially in hot ambient conditions, it may be necessary to flow a coolant through the thermal channels 260 to cool the plate 250 and to thereby cool the fuel cell. The fluid carrying channels 260 permit this type of cooling to occur. Alternatively, in cold ambient conditions, it may be necessary to heat the fuel cell to maintain proper operation. Again, the fluid carrying channels 260 permit a heated fluid to flow into the plate 250 without having the fluid intermingle with the reaction fuel or products. While a mono-polar plate is shown, a bipolar plate can easily be designed with the above-described feature. This feature is especially well-suited for a manufacturing method wherein the plate is formed by extrusion.

Many variations on plate designs are possible within the scope of the present invention. In one embodiment, for example, a metal layer is formed onto the surface of the conductive loaded resin-based material fuel cell plate.

The conductive loaded resin-based material provides a number of useful advantages in a mono-polar and bipolar fuel cell plate. Due to the network of conductive fiber and/or powder, the material displays excellent electrical conductivity such that an efficient power transfer is achieved. The material additionally displays excellent thermal conductivity such that thermal energy is easily transferred into or out from the fuel cell to thereby maintain proper operating temperature. The material, especially with the selection of a non-corrosive conductive loading, further displays excellent resistance to corrosion. The material is imperviousness to fuel intrusion due to the material properties of the base resin selected. The plates of the present invention are substantially lighter than all-metal versions of the prior art. As a result, a lighter weight fuel cell is formed. This is particularly important in mobile applications. Conductive loaded resin-based material plates are easy to manufacture using standard plastics processing technology. Thermoplastic and thermosetting resin-based materials may be used as the base resin.

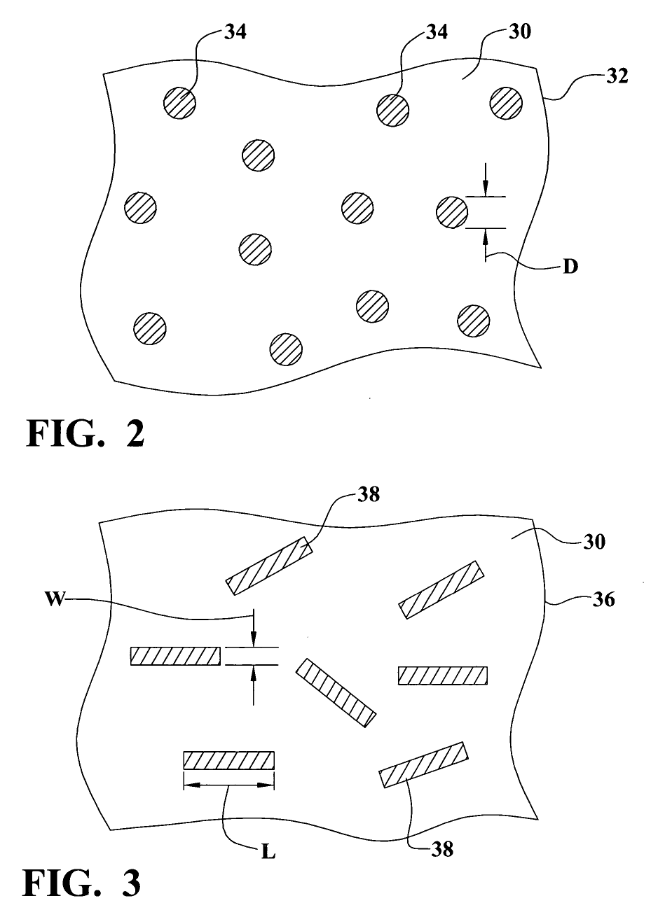

The conductive loaded resin-based material of the present invention typically comprises a micron powder(s) of conductor particles and/or in combination of micron fiber(s) substantially homogenized within a base resin host. FIG. 2 shows cross section view of an example of conductor loaded resin-based material 32 having powder of conductor particles 34 in a base resin host 30. In this example the diameter D of the conductor particles 34 in the powder is between about 3 and 12 microns.

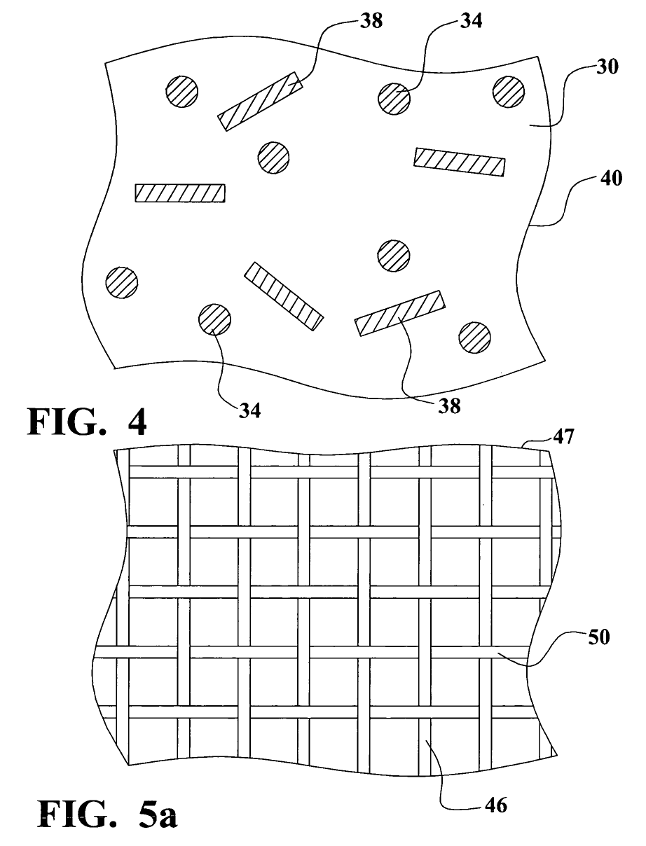

FIG. 3 shows a cross section view of an example of conductor loaded resin-based material 36 having conductor fibers 38 in a base resin host 30. The conductor fibers 38 have a diameter of between about 3 and 12 microns, typically in the range of 10 microns or between about 8 and 12 microns, and a length of between about 2 and 14 millimeters. The conductors used for these conductor particles 34 or conductor fibers 38 can be stainless steel, nickel, copper, silver, aluminum, or other suitable metals or conductive fibers, or combinations thereof. Superconductor metals, such as titanium, nickel, niobium, and zirconium, and alloys of titanium, nickel, niobium, and zirconium may also be used as micron conductive fibers in the present invention. These conductor particles and or fibers are substantially homogenized within a base resin. As previously mentioned, the conductive loaded resin-based materials have a sheet resistance between about 5 and 25 ohms per square, though other values can be achieved by varying the doping parameters and/or resin selection. To realize this sheet resistance the weight of the conductor material comprises between about 20% and about 50% of the total weight of the conductive loaded resin-based material. More preferably, the weight of the conductive material comprises between about 20% and about 40% of the total weight of the conductive loaded resin-based material. More preferably yet, the weight of the conductive material comprises between about 25% and about 35% of the total weight of the conductive loaded resin-based material. Still more preferably yet, the weight of the conductive material comprises about 30% of the total weight of the conductive loaded resin-based material. Stainless Steel Fiber of 6-12 micron in diameter and lengths of 4-6 mm and comprising, by weight, about 30% of the total weight of the conductive loaded resin-based material will produce a very highly conductive parameter, efficient within any EMF spectrum. Referring now to FIG. 4, another preferred embodiment of the present invention is illustrated where the conductive materials comprise a combination of both conductive powders 34 and micron conductive fibers 38 substantially homogenized together within the resin base 30 during a molding process.

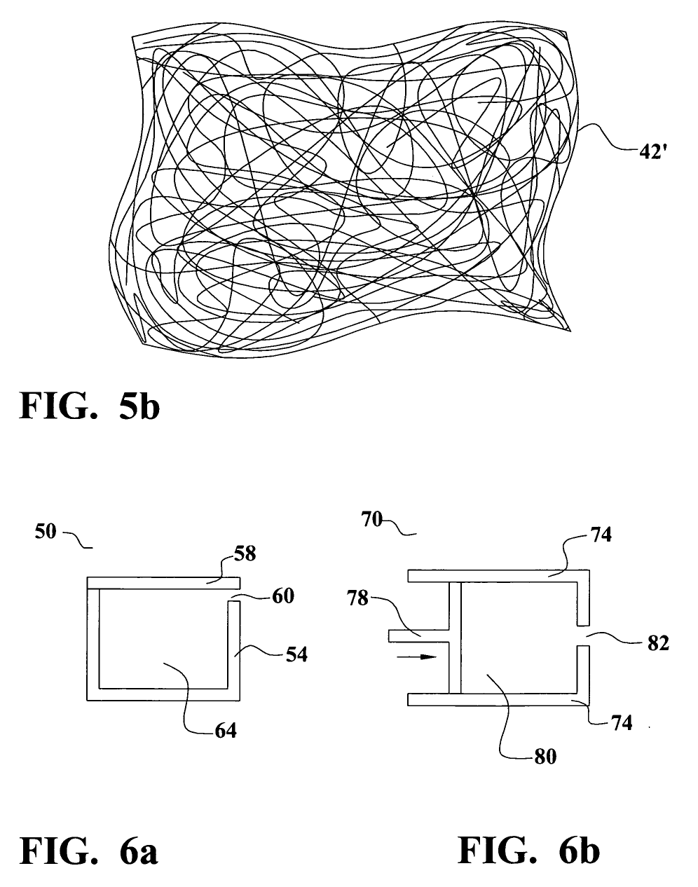

Referring now to FIGS. 5a and 5b, a preferred composition of the conductive loaded, resin-based material is illustrated. The conductive loaded resin-based material can be formed into fibers or textiles that are then woven or webbed into a conductive fabric. The conductive loaded resin-based material is formed in strands that can be woven as shown. FIG. 5a shows a conductive fabric 42 where the fibers are woven together in a two-dimensional weave 46 and 50 of fibers or textiles. FIG. 5b shows a conductive fabric 42′ where the fibers are formed in a webbed arrangement. In the webbed arrangement, one or more continuous strands of the conductive fiber are nested in a random fashion. The resulting conductive fabrics or textiles 42, see FIG. 5a, and 42′, see FIG. 5b, can be made very thin, thick, rigid, flexible or in solid form(s).

Similarly, a conductive, but cloth-like, material can be formed using woven or webbed micron stainless steel fibers, or other micron conductive fibers. These woven or webbed conductive cloths could also be sandwich laminated to one or more layers of materials such as Polyester(s), Teflon(s), Kevlar(s) or any other desired resin-based material(s). This conductive fabric may then be cut into desired shapes and sizes.

Mono-polar and bipolar plates formed from conductive loaded resin-based materials can be formed or molded in a number of different ways including injection molding, extrusion or chemically induced molding or forming. FIG. 6a shows a simplified schematic diagram of an injection mold showing a lower portion 54 and upper portion 58 of the mold 50. Conductive loaded blended resin-based material is injected into the mold cavity 64 through an injection opening 60 and then the substantially homogenized conductive material cures by thermal reaction. The upper portion 58 and lower portion 54 of the mold are then separated or parted and the plates are removed.

FIG. 6b shows a simplified schematic diagram of an extruder 70 for forming mono-polar and bipolar plates using extrusion. Conductive loaded resin-based material(s) is placed in the hopper 80 of the extrusion unit 74. A piston, screw, press or other means 78 is then used to force the thermally molten or a chemically induced curing conductive loaded resin-based material through an extrusion opening 82 which shapes the thermally molten curing or chemically induced cured conductive loaded resin-based material to the desired shape. The conductive loaded resin-based material is then fully cured by chemical reaction or thermal reaction to a hardened or pliable state and is ready for use. Thermoplastic or thermosetting resin-based materials and associated processes may be used in molding the conductive loaded resin-based articles of the present invention.

The advantages of the present invention may now be summarized. An effective mono-polar or bipolar fuel cell plate is achieved. A method to form a mono-polar or bipolar fuel cell plate is also achieved. The mono-polar or bipolar fuel cell plate is molded of conductive loaded resin-based materials. The fuel cell plate exhibits excellent resistance to corrosion, electrical and thermal conductivity, low weight, and ease of manufacture. The fuel cell plate is compatible with metal plating.

As shown in the preferred embodiments, the novel methods and devices of the present invention provide an effective and manufacturable alternative to the prior art.

While the invention has been particularly shown and described with reference to the preferred embodiments thereof, it will be understood by those skilled in the art that various changes in form and details may be made without departing from the spirit and scope of the invention.

1. A conductive fuel cell plate device comprising a substrate comprising a conductive loaded, resin-based material comprising conductive materials in a base resin host wherein a first channel is formed on a side of said substrate.

2. The device according to claim 1 wherein the percent by weight of said conductive materials is between about 20% and about 50% of the total weight of said conductive loaded resin-based material.

3. The device according to claim 1 wherein said conductive materials comprise micron conductive fiber.

4. The device according to claim 2 wherein said conductive materials further comprise conductive powder.

5. The device according to claim 1 wherein said conductive materials are metal.

6. The device according to claim 1 wherein said conductive materials are non-conductive materials with metal plating.

7. The device according to claim 1 further comprising a second channel formed on said substrate.

8. The device according to claim 7 wherein said second channel is on the side opposite said first channel.

9. The device according to claim 1 further comprising a metal layer overlying said conductive loaded resin-based material.

10. The device according to claim 1 wherein said base resin is a thermoset material.

11. The device according to claim 1 wherein said base resin is a thermoplastic material.

12. A fuel cell device comprising:
a cathode end plate comprising a conductive loaded, resin-based material comprising conductive materials in a base resin host wherein a channel is formed on a side of said cathode end plate;
a proton conducting membrane; and
an anode end plate comprising said conductive loaded, resin-based material wherein a channel is formed on a side of said cathode end plate and wherein said proton conducting membrane is between said cathode end plate and said anode end plate.

13. The device according to claim 12 wherein said conductive materials are nickel plated carbon micron fiber, stainless steel micron fiber, copper micron fiber, silver micron fiber or combinations thereof.

14. The device according to claim 12 wherein said conductive materials comprise micron conductive fiber and conductive powder.

15. The device according to claim 14 wherein said conductive powder is nickel, copper, or silver.

16. The device according to claim 14 wherein said conductive powder is a non-conductive material with a metal plating of nickel, copper, silver, or alloys thereof.

17. The device according to claim 12 further comprising:
a bipolar plate comprising said conductive loaded resin-based material wherein a first channel is formed on a first side of said bipolar plate and wherein a second channel is formed on a second side of said bipolar plate; and
a second said proton conducting membrane.

18. The device according to claim 12 further comprising a metal layer overlying said conductive loaded resin-based material.

19. The device according to claim 12 wherein said base resin is a thermoset material.

20. The device according to claim 12 wherein said base resin is a thermoplastic material.

21. A fuel cell device comprising:
a cathode end plate comprising a conductive loaded, resin-based material comprising conductive materials in a base resin host wherein a channel is formed on a side of said cathode end plate and wherein the percent by weight of said conductive materials is between 20% and 40% of the total weight of said conductive loaded resin-based material;
a proton conducting membrane; and
an anode end plate comprising said conductive loaded, resin-based material wherein a channel is formed on a side of said cathode end plate and wherein said proton conducting membrane is between said cathode end plate and said anode end plate.

22. The device according to claim 21 wherein said conductive material is stainless steel micron conductive fiber.

23. The device according to claim 22 further comprising conductive powder.

24. The device according to claim 22 wherein said micron conductive fiber has a diameter of between about 3 μm and about 12 μm and a length of between about 2 mm and about 14 mm.

25. The device according to claim 21 further comprising:
a bipolar plate comprising said conductive loaded resin-based material wherein a first channel is formed on a first side of said bipolar plate and wherein a second channel is formed on a second side of said bipolar plate; and
a second said proton conducting membrane.
